(19) United States
(12) Patent Application Publication
(10) Pub. No.: US 2026/0366689 A1
(43) Pub. Date: Nov. 19, 2026

(54) VEHICLE LIGHTING DEVICE HAVING A LIGHT GUIDE PROVIDED WITH A MULTILAYER STRUCTURE

(71) Applicant: VALEO VISION, Bobigny (FR)

(72) Inventors: Eduardo ALV EAR, Bobigny (FR); Mickael MIMOUN, Bobigny (FR); Rabih TALEB, Bobigny (FR); Hafid EL-IDRISSI, Bobigny (FR)

(73) Assignee: VALEO VISION, Bobigny (FR)

(21) Appl. No.: 19/137,561

(22) PCT Filed: Dec. 15, 2023
(86) PCT No.: PCT/EP2023/086215

§ 371 Date: Jun. 10, 2025

(30) Foreign Application Priority Data
Dec. 16, 2022 (FR) FR2213702

(51) Int. Cl. F21S 41/64; F21S 41/24

(52) U.S. Cl. CPC F21S 41/645; F21S 41/24

(57) ABSTRACT

The invention relates to a vehicle lighting device. The lighting device includes at least a partially transparent or translucent light guide, and a light source arranged at one end of the light guide. The light guide includes a transparent or translucent core with the light source being configured to emit a source beam into the core of the light guide. The light guide also includes a multilayer structure that is attached to the core. The multilayer structure includes a substrate, a reflective layer and a layer of electrochromic material structured into a plurality of elements, each element being encapsulated in a layer of electrolyte and being connected to a pair of electrodes capable of receiving an electrical voltage. The lighting device further includes an electrical control circuit configured to control the electrical voltage across the terminals of each pair of electrodes.

### TECHNICAL FIELD

The present invention belongs to the field of lighting, in particular of lighting for an automotive vehicle. The invention relates in particular to a vehicle luminous device comprising an at least partially transparent or translucent light guide, as well as to a method of controlling such a luminous device. Without this being limiting in the context of the present invention, the luminous device may be mounted in a headlamp of an automotive vehicle. The present invention is also applicable to luminous devices intended for photometric lighting and/or signaling functions of a vehicle, for the interior lighting of the latter (mounted, for example, in the ceiling light of the vehicle), or even to luminous devices which produce a signature or visual animations on the vehicle.

### BACKGROUND OF THE INVENTION

In the field of automotive lighting, luminous devices mounted in a headlamp of the vehicle to project luminous beams performing photometric lighting and/or signaling functions are generally known. In particular, in order to perform a direction-indicating function of the vehicle, the luminous beam may be a scrolling lighting beam, i.e. produce what is called a “sequential” effect. The latter is obtained using a luminous device which conventionally comprises an at least partially transparent or translucent light guide, two essentially point-like luminous sources, of the light-emitting diode type, arranged at the ends of the light guide, and a control device for controlling the two luminous sources.

Published patent document U.S. Pat. No. 10,436,413 B2 discloses such a luminous device. The control device present within the luminous device is configured to control the turning-on of each of the luminous sources. More precisely, during the method of controlling the turning-on of the luminous sources, the two luminous sources are controlled according to different control laws so as to create a lighting effect of the scrolling or “sequential” type from one side of the light guide to the other side of the light guide. In other words, the light appears to move in the light guide from the first luminous source to the second luminous source until the light guide is fully lit.

However, the luminous device described in this patent document requires two luminous sources, arranged at the two ends of the light guide. Furthermore, it does not allow segmentation (also called pixelation) of the light emitted by the light guide. For this purpose, it is known to use a luminous device comprising a light guide, and a plurality of essentially point-like luminous sources, of the light-emitting diode type, arranged along the entire length of the light guide. Each luminous source is then configured to emit light into the core of the light guide, and corresponds to a distinct pixel. However, such a solution is unsuitable when it is desired to obtain a light guide which is flexible and/or has a particular geometry, due to the arrangement of all the luminous sources along the light guide. Furthermore, such a solution requires a particular distance between luminous sources to be chosen, this being restrictive, and also entails significant costs due to the multiplicity of luminous sources.

### SUMMARY OF THE INVENTION

The present invention improves the situation.

One objective of the invention is to propose a vehicle luminous device comprising an at least partially transparent or translucent light guide, which allows segmentation (or pixelation) of the light guide while using only one luminous source arranged at one end of the light guide, all while easing constraints and reducing costs. Another objective is to propose such a luminous device which makes it possible to use a light guide which is flexible and/or has any type of geometry.

For this purpose, a first aspect of the invention relates to a vehicle luminous device comprising an at least partially transparent or translucent light guide, and a luminous source arranged at one end of the light guide, the light guide comprising a transparent or translucent core, the luminous source being configured to emit a source beam into the core of the light guide. Herein, “light guide” is understood to mean any optical part capable of guiding light along its length by total internal reflection of this light, for example from an entrance region to an exit region.

Furthermore, the light guide core is configured so as to allow light to exit this part via at least one lateral side thereof, that is to say via a face of the optical part the normal of which is perpendicular to the longitudinal axis of the part along which the part extends. To do this, by way of example, the light guide core may comprise return elements for reflecting luminous rays toward the lateral side. The return elements may be microstructures, prisms, or even suspended particles integrated in the light guide core.

The light guide is typically a cylindrical light guide or a surface light guide. Optionally, but preferably, the light guide is an optical fiber, typically a diffusing and/or flexible optical fiber. The luminous source is preferably an essentially point-like luminous source, of the light-emitting diode type.

According to the invention, the light guide further comprises a multilayer structure attached to the core and comprising a substrate, a reflective layer, and a layer of electrochromic material structured into a plurality of elements, each element being encapsulated in a layer of electrolyte and being connected to a pair of electrodes capable of receiving a voltage, each element being capable of receiving luminous rays incident from a surface and of returning luminous rays from among the luminous rays incident from said surface, said returned luminous rays having a wavelength within a range defined at least by properties of the electrochromic material of said layer and/or by a thickness of the layer of electrochromic material,
and the luminous device further comprises an electrical control circuit configured to control the voltage across the terminals of each pair of electrodes such that when the electrical control circuit imposes a predefined voltage value across the terminals of at least one of the pairs of electrodes, the light coming from the source beam and reflected by the reflective layer passes through the corresponding element and emerges into the core of the light guide with a predetermined wavelength in the visible spectrum, said wavelength being a function of said predefined voltage value across the terminals of said at least one pair of electrodes.

By virtue of the presence of such a multilayer structure configured in this way, the luminous device according to the invention allows segmentation (or pixelation) of the light guide while using only a single luminous source arranged at one end of the light guide, this helping to ease constraints and reduce costs. Furthermore, the luminous device according to the invention makes it possible to use a light guide which is flexible and/or has any type of geometry, unlike the solution of the prior art consisting in arranging numerous luminous sources along the length of the light guide. Finally, the luminous device according to the invention is particularly compact, allows a variable distance between elements, and imposes fewer limitations with regard to the number of frames in the visual animation generated.

Preferably, the radiation of the source beam is partially or entirely in the visible spectrum.

Advantageously, all the elements of the layer of electrochromic material are identical (in other words of the same dimensions when not electrically powered).

According to one preferred embodiment of the invention, the luminous source is configured to emit a monochrome source beam having said predetermined wavelength in the visible spectrum. This makes it possible to obtain better efficiency in terms of luminous intensity returned at the output of the light guide, in other words downstream of the layer of electrochromic material (upstream and downstream being defined relative to the direction of travel of the light emitted by the luminous source and reflected by the reflective layer). For example, it is possible to use a luminous source configured to emit red light, the elements of the layer of electrochromic material then being electrically powered so as to cause only red luminous rays to emerge downstream. Such a light guide configured in this way allows the luminous device to perform a signaling function of the flashing or stop-light type. For example again, it is also possible to use a luminous source configured to emit blue light, the elements of the layer of electrochromic material each encapsulated in the electrolyte layer then being electrically powered so as to cause only blue luminous rays to emerge downstream. This makes it possible to obtain a very high luminous efficiency returned at the output of the light guide (large amount of blue rays obtained at the output).

According to one embodiment of the invention, the luminous source is a laser source or a light-emitting diode.

According to one embodiment of the invention, the electrochromic material belongs to the family of organic transparent conductive oxide materials, in particular a transparent conductive polymer of PEDOT:PSS, PEDOT:Tos, T34bT, or cellulose type. Such a material makes it possible to produce a Fabry-Pérot cavity, which is flexible and transparent. Moreover, such an electrochromic material is in contact with the electrolyte layer so that under electrical stimulation, for example when a voltage is applied to the electrolyte layer, the ions of the electrolyte layer migrate into the layer of electrochromic material. The amount of “migrating” ions depends on the value of the electrical quantity applied. The more “migrating” ions, the thicker the layer of electrochromic material.

Oxidation-reduction reactions may occur between the layer of electrochromic material and the “migrating” ions so as to modify the thickness and/or the properties of this layer. The layer of electrochromic materials is thus electrochemically adjustable.

Optionally, the light guide is a diffusing and/or flexible optical fiber. By definition, an optical fiber comprises a core part and a sheath surrounding the core. Generally, the sheath is transparent while the core part allows total internal reflection. The refractive index of the core part is then slightly higher than the refractive index of the sheath surrounding the core. Fiber optic light guides allow light to be guided from a luminous source to various locations without having to suffer significant transmission losses. Such an optical fiber has the advantage, in addition to its flexibility which makes it suitable for certain applications, of having a homogeneous structure (unlike rigid and extruded light guides, for example, which have asperities).

According to one embodiment of the invention, the voltage across the terminals of each pair of electrodes is between −1 V and +1 V. Such control may be ensured in practice by low voltage levels, less than 1 V in absolute value for the layer of electrochromic material, this leading to low energy consumption.

By way of example, the pair of electrodes comprises a working electrode and a system of electrodes comprising a counter electrode and a reference electrode.

According to one embodiment of the invention, the light guide further comprises a layer of phosphor material attached to the core of the light guide, opposite the multilayer structure. When the electrical control circuit imposes a predefined voltage value corresponding to a blue color reflected at the output of the layer of electrochromic material, such a characteristic makes it possible to obtain white luminous radiation at the output of the light guide. The light guide configured in this way allows the luminous device to perform, for example, an automotive signaling function of daytime running light type, or a decorative function for a welcome scenario, with a possibility of creating luminous animations.

According to another embodiment of the invention, the light guide further comprises a photoluminescent layer of quantum dot nano-materials, said photoluminescent layer being attached to the core of the light guide, opposite the multilayer structure. This makes it possible to obtain high illuminance as well as good visibility at the output of the light guide, while minimizing the energy consumption of the luminous device.

Herein, “quantum dot” is understood to mean an electronic structure obtained from a semiconductor nanocrystal, of a size such that its electrons and its holes are confined in the three dimensions of space. Depending on the particular size of the quantum dot, the quantum dot emits light in a particular wavelength (band gap) when excited, either electrically or by luminescence. Quantum dots are generally deposited within a nanometric layer using homogeneous thin-film deposition technology. By controlling the amount and the density of the quantum dots, this layer may not be visible when it is not excited by an electrical or luminescent stimulator.

Advantageously, the size of the quantum dots is chosen such that the light coming from the multilayer structure passes through the photoluminescent layer with a first predetermined wavelength in the visible spectrum, and emerges from the photoluminescent layer with a second predetermined wavelength in the visible spectrum. This makes it possible to obtain luminous radiation in the visible spectrum at the output of the light guide, the wavelength of which corresponds to the second predetermined wavelength and may advantageously be chosen by adapting the size of the quantum dots. Preferably, the first predetermined wavelength in the visible spectrum is substantially equal to 450 nm and corresponds to a monochrome source beam in the blue region of the visible spectrum.

According to one embodiment of the invention, the light guide further comprises an encapsulation layer encapsulating the photoluminescent layer.

According to one embodiment of the invention, the substrate of the multilayer structure is provided with a power supply ribbon cable connected on the one hand to the electrical control circuit and on the other hand to the terminals of each pair of electrodes.

Advantageously, the power supply ribbon cable consists of a flexible printed circuit board or of a film on which electronic components are printed.

Another subject of the invention relates to a vehicle headlamp, in particular of an automotive vehicle, comprising a luminous device according to the invention.

Another subject of the invention relates to a vehicle comprising a luminous device according to the invention.

Herein, “vehicle” is understood to mean any type of vehicle such as an automotive vehicle, a moped, a motorbike, a warehouse robot, or any other machine able to carry at least one passenger or intended to transport people or objects.

Another subject of the invention relates to a method of controlling a vehicle luminous device according to the invention, the method being implemented by the electrical control circuit and comprising a control step of controlling at least one voltage across the terminals of the pair of electrodes of an element of the multilayer structure, depending on a setpoint, said setpoint being such that the light coming from the source beam and reflected by the reflective layer passes through said element and emerges into the core of the light guide with said predetermined wavelength in the visible spectrum.

Another subject of the invention relates to the use of a luminous device according to the invention for performing a photometric lighting and/or signaling function of a vehicle, in particular a direction-indicating function of the vehicle

### BRIEF DESCRIPTION OF THE DRAWINGS

Other features and advantages of the invention will become apparent on examining the following detailed description and the appended drawings, in which:

FIG. 1 is a schematic representation, in a side view, of a luminous device according to the invention, the luminous device comprising a luminous source and an electrical control circuit;

FIG. 2 is a schematic representation, in a longitudinal cross-sectional view, of the luminous device of FIG. 1 according to a first embodiment of the invention, the luminous device comprising a layer of electrochromic material structured into a plurality of elements and being in an operating mode in which none of the elements of the layer is electrically powered by the electrical control circuit;

FIG. 3 is a view similar to that of FIG. 2, in an operating mode of the luminous device in which two of the elements of the layer are electrically powered by the electrical control circuit;

FIG. 4 is a view similar to that of FIG. 2, in an operating mode of the luminous device in which all of the elements of the layer are electrically powered by the electrical control circuit;

FIG. 5 is a schematic representation, in a longitudinal cross-sectional view, of the luminous device of FIG. 1 according to a second embodiment of the invention; and

FIG. 6 is a schematic representation, in a longitudinal cross-sectional view, of the luminous device of FIG. 1 according to a third embodiment of the invention.

In this document, the terms “horizontal”, “vertical” or “transverse”, “lower”, “upper”, “high”, “low”, and “side” are defined with respect to the orientation with which the luminous device according to the invention, or a component forming part of the luminous device according to the invention, is intended to be mounted in the vehicle. In particular, in this patent application, the term “vertical” designates an orientation perpendicular to the horizon, while the term “horizontal” designates an orientation parallel to the horizon.

### DETAILED DESCRIPTION OF THE INVENTION

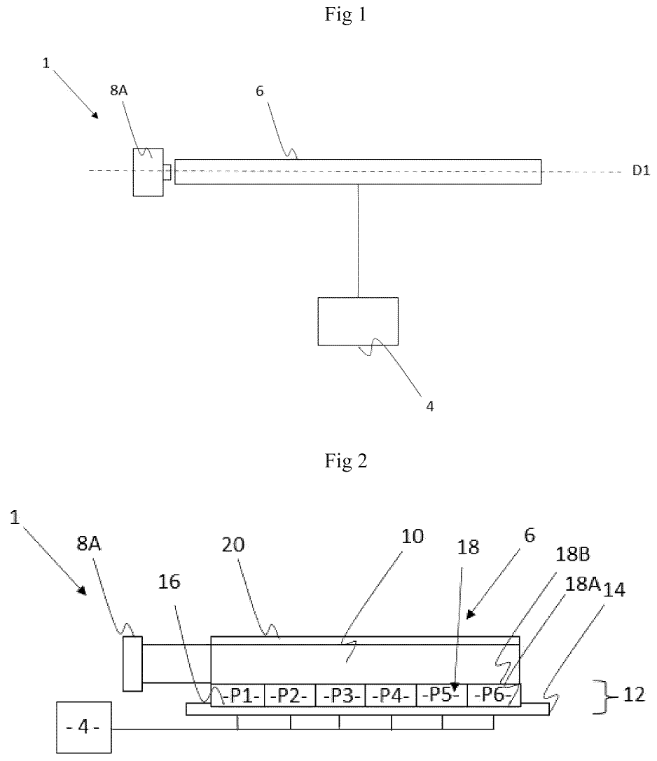

FIG. 1 is a schematic representation, in a side view, of a vehicle luminous device 1 according to the invention. The luminous device 1 comprises an at least partially transparent or translucent light guide 6, a luminous source 8A, and an electrical control circuit 4. The electrical control circuit 4 is, for example, connected to the electrical network of the vehicle.

As illustrated in FIGS. 2 to 6, the light guide 6 comprises a transparent or translucent core 10 and a sheath (not shown) surrounding the core 10. The light guide 6 further comprises a multilayer structure 12 attached to the core 10.

The light guide 6 is elongate in a substantially horizontal main direction of extension D1. The light guide 6 is typically a cylindrical light guide or a surface light guide, for example of square or round section. According to one example, the light guide 6 is a linear diffusing optical fiber, folded or not, and made of a flexible material, without this being limiting in the context of the present invention. The optical fiber 6 is advantageously made of an at least partially transparent or translucent plastic material, in particular of polycarbonate (also called PC) or else polymethyl methacrylate (also called PMMA). The optical fiber 6 is, for example, made of a material similar to PMMA for the core of the fiber, and of another material similar to a fluoropolymer for the sheath. The optical fiber 6 is, for example, obtained by a prior extrusion process, or by any other known manufacturing process.

As illustrated in FIGS. 2 to 6, the multilayer structure 12 is composed of the stack of a substrate 14, a reflective layer 16, and a layer of electrochromic material 18.

The substrate 14 is typically a flexible substrate. For example, the flexible substrate 14 is made of silicone, of polycarbonate or of PMMA. The substrate 14 has, for example, a thickness of 500 microns. The substrate 14 is, for example, provided with a power ribbon cable connected to the electrical control circuit 4. The power supply ribbon cable typically consists of a flexible printed circuit board or of a film on which electronic components are printed.

The reflective layer 16 is typically a metal layer. The metal layer 16 is delimited by a first face and a second face. The first face of the metal layer 16 is in contact with a face of the substrate 14. For example, the metal layer 16 may be made of aluminum, of chromium or of gold, or also of an alloy of at least two metals from among the three metals mentioned above. The metal layer 16 has, for example, a thickness of between 70 and 100 nm.

The layer of electrochromic material 18 is delimited by a third face 18A and a fourth face 18B. Electrochromic means a material which changes color when a voltage is applied to it for a short period of time. The change in color is due to the fact that only one specific type of wavelength, for example wavelengths of a specific value or in a specific visible color spectrum, may exit the layer of electrochromic material 18 as a function of the value of the electrical quantity applied. These specific wavelengths correspond to a color in the visible spectrum and reach the eyes of an observer. The latter therefore has the impression that the layer of material 18 has changed color. The material retains the new color after application for as long as the voltage is applied to it. The third and fourth faces 18A, 18B of the layer of electrochromic material 18 are substantially parallel to each other. The third face 18A of the layer of electrochromic material 18 is in contact with the second face of the metal layer 16. An incident luminous wave, having a given wavelength spectrum, enters from the fourth face 18B and then interferes with the electrochromic material 18. The interference phenomenon leads to the electrochromic material 18 returning luminous rays from the fourth face 18B only in a restricted wavelength range, or, more simply, according to a given color. The color returned by the layer of electrochromic material 18 is conditioned by the thickness of the cavity and/or by the intrinsic properties of the electrochromic material 18, in particular its permittivity, as well as by the reflective layer 16 used.

The electrochromic material is, for example, a polymer, such as a polymer of PEDOT (poly(3,4-ethylenedioxythiophene)) type. The PEDOT material used may be, for example, PEDOT:PSS, also called poly(3,4-ethylenedioxythiophene):poly(sodium styrene sulfonate), or PEDOT:Tos, also called poly(3,4-ethylenedioxythiophene):tosylate. Other examples of organic transparent conductive oxide materials which may be used for the electrochromic material are cellulose-based. Such a family of organic transparent conductive oxide materials, also known as transparent conductive oxides (TCOs), makes it possible to produce a Fabry-Pérot cavity, which is flexible and transparent. Moreover, such an electrochromic material is electrochemically adjustable insofar as oxidation-reduction reactions (also commonly called “redox” reactions) may occur between this type of material and the electrolyte under electrical stimulation (for example under a voltage). Of course, other materials may be used as long as they have properties suitable for an automotive application, such as high ionic conductivity, a transparent or colorless physical appearance in a resting state, flexible, as well as electro-optical properties for forming a Fabry-Pérot cavity in an excited state. Furthermore, the material may be packed as a solid cell. No restriction is imposed on the electrochromic material used in the layer of electrochromic material 18. The electrochromic material may in particular be an organic material or an inorganic material.

Here, the layer of electrochromic material 18 is structured into N elements or pixels. Herein, “pixel” is specifically understood to mean a cell or individual element of the layer of electrochromic material 18. A portion of the multilayer structure with N pixels P1, P2, P3, . . . and PN is shown in FIGS. 2 to 6, with N equal to 6. For example, the layer of electrochromic material 18 is structured into a row of N pixels. In the example illustrated, the row of N pixels extends along the main direction of extension D1. Each pixel from among the N pixels is encapsulated in an electrolyte gel or solution, connected to which is a pair of electrodes intended to voltage-bias the corresponding pixel. The encapsulation and the arrangement of the N pixels and the arrangement of the corresponding N pairs of electrodes on each pixel are performed similarly to those for a liquid-crystal plate. The set of N pairs of electrodes is connected to a low-voltage battery (not shown) and connected to the electrical control circuit 4 via the power supply ribbon cable of the substrate 14.

The way in which the color of one pixel from among the N pixels of the layer of electrochromic material 18 is controlled is described below. Such a pixel acts as a Fabry-Pérot cavity formed by the corresponding portion of the third face 18A and the corresponding portion of the fourth face 18B. This cavity produces, from the light it receives, interference of a determined wavelength. This interference results in multiple reflections of rays of a given wavelength propagating inside the cavity. It is thus by a phenomenon of interference, and not of absorption as when pigments or dyes are used, that the pixel produces, for an observer, a coloration. Such a color is called “structural” because it is obtained by interference of incident luminous rays with the electrochromic material. The layer of electrochromic material 18 is thin on a sub-wavelength scale, for example of the order of a few nanometers in thickness or between 50 and 800 nm, for example between 75 and 300 nm, and is therefore both compact and light. Since the display function is structurally linked to the layer of electrochromic material, the luminous device 1 is also very robust, in particular to mechanical shocks and to variations in temperature. A Fabry-Pérot cavity may return approximately between 60% and 90% of the incident luminous intensity, this allowing good visibility of the luminous device 1 in sunny weather. More details about such a layer of electrochromic material 18, as well as about how to choose a color from the UV treatment which is applied to the electrochromic material, in particular the intensity of the treatment and its duration, as a function of the electrochromic material and as a function of the reflective layer 16, are detailed in the article “Tunable Structural Color Images by UV-Patterned Conducting Polymer Nanofilms on Metal Surfaces”, by Shangzi Chen et al., Advanced Materials, 2021, 33, 2102451, published by Wiley-VCH GmbH.

Each element or pixel P1, P2, P3, . . . and PN of the layer of electrochromic material 18 is thus capable of receiving luminous rays incident from a surface corresponding to the fourth face 18B of the layer of electrochromic material 18, and of returning luminous rays from among the luminous rays incident from this surface 18B. As indicated above, the returned luminous rays have a wavelength within a range defined at least by properties of the electrochromic material and/or by a thickness of the layer of electrochromic material 18.

The luminous source 8A is arranged at one end of the light guide 6 and is configured to emit a source beam into the core 10 of the light guide 6. The luminous source 8A is advantageously an essentially point-like luminous source, in particular of the semiconductor type, for example of the light-emitting diode type or else a laser source. According to one preferred embodiment of the invention, the luminous source 8A is configured to emit a monochrome source beam having a predetermined wavelength in the visible spectrum.

The electrical control circuit 4 makes it possible to control the voltage across the terminals of the N elements or pixels of the layer of electrochromic material 18. A table of correspondence between the desired color and the voltage to be applied across the terminals of a pair of electrodes makes it possible to control the change in color of the corresponding pixel via the voltage. The table of correspondence depends on the electrochromic material used. For example, the voltage across the terminals of a pair of electrodes varies between a minimum voltage of −1 Volt and a maximum voltage of +1 Volt. The thickness of the layer of electrochromic material 18 has an influence on the color perceived by an observer. For example, a PEDOT layer having a thickness equal to 220 nm, when it receives light of a broadband luminous spectrum, produces a red color by reflection. A PEDOT layer having a thickness equal to 170 nm, when it receives light of a broadband luminous spectrum, produces a green color by reflection. A PEDOT layer having a thickness equal to 130 nm, when it receives light of a broadband luminous spectrum, produces a blue color by reflection. In the present invention, all the elements P1, P2, P3, . . . and PN of the layer of electrochromic material 18 are identical (therefore of the same thickness when no voltage is applied to them), but the thickness of the layer of electrochromic material 18 depends on the supply voltage provided by the electrical control circuit 4, this therefore influencing the color perceived by an observer. For example, for a supply voltage across the terminals of a pair of electrodes of substantially equal to 0.3 Volt, a layer 18 of PEDOT material produces a blue color by reflection (having a wavelength of substantially equal to 450 nm); for a supply voltage across the terminals of a pair of electrodes of substantially equal to 0.6 Volt, a layer 18 of PEDOT material produces a green color by reflection; for a supply voltage across the terminals of a pair of electrodes of substantially equal to 0.9 Volt, a layer 18 of PEDOT material produces a red color by reflection (having a wavelength of between 620 nm and 630 nm).

Thus, the electrical control circuit 4, by receiving a setpoint sent, for example, by a user, makes it possible to control the voltage across the terminals of each pair of electrodes in order to control the color of the corresponding pixel. More precisely, when the electrical control circuit 4 imposes a predefined voltage value across the terminals of one of the pairs of electrodes, the light coming from the source beam (emitted by the luminous source 8A) and reflected by the reflective layer 16 passes through the corresponding element or pixel P1, P2, P3, . . . PN, and emerges into the core 10 of the light guide 6 with a predetermined wavelength in the visible spectrum. This predetermined wavelength is a function of the predefined voltage value imposed across the terminals of the corresponding pair of electrodes. Advantageously, the wavelength of the monochrome source beam emitted by the luminous source 8A is the same as this predetermined wavelength. This makes it possible to obtain better efficiency in terms of luminous intensity returned at the output of the light guide 6, in other words downstream of the layer of electrochromic material 18.

The photometric lighting and/or signaling function, or the signature or visual animation, produced by the luminous device 1, thus consists of the N pixels the color of which is controlled by the voltages imposed by the electrical control circuit 4. This photometric lighting and/or signaling function, or this signature or visual animation, is thus customizable.

FIGS. 2 to 4 show the luminous device 1 according to a first embodiment of the invention, in which the light guide 6 further comprises a layer of phosphor material 20 attached to the core 10 of the light guide 6, opposite the multilayer structure 12. When the luminous source 8A emits a monochrome source beam in the blue region of the visible spectrum (and the electrical control circuit 4 imposes a predefined voltage value corresponding to a blue color reflected at the output of the layer of electrochromic material 18), the presence of such a layer of phosphor material 20 makes it possible to obtain white luminous radiation at the output of the light guide 6.

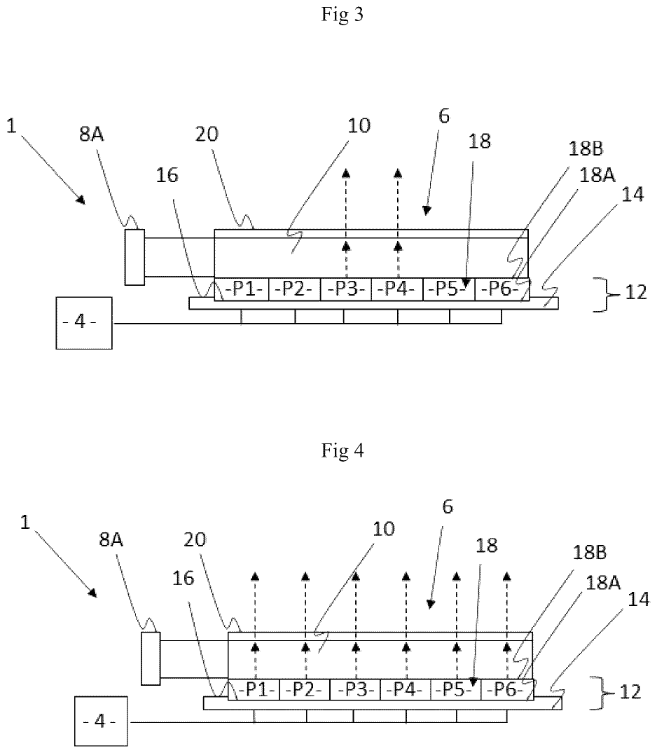

In FIG. 2, none of the elements or pixels P1, P2, P3, . . . PN of the layer of electrochromic material 18 is electrically powered by the electrical control circuit 4. In FIG. 3, two elements or pixels P3, P4 of the layer of electrochromic material 18 are electrically powered (via their respective pairs of electrodes) by the electrical control circuit 4. Finally, in FIG. 4, all the elements or pixels P1, P2, P3, . . . PN are electrically powered (via their respective pairs of electrodes) by the electrical control circuit 4.

FIG. 5 shows the luminous device 1 according to a second embodiment of the invention, in which the light guide 6 further comprises a photoluminescent layer 22 of quantum dot nano-materials, attached to the core 10 of the light guide 6, opposite the multilayer structure 12. Preferably, as illustrated in FIG. 5, the light guide 6 further comprises an encapsulation layer 24 encapsulating the photoluminescent layer 22, such an encapsulation layer 24 being intended to protect a user from the photoluminescent layer 22. Preferably, the size of the quantum dots of the photoluminescent layer 22 is chosen such that the light coming from the multilayer structure 12 passes through the photoluminescent layer 22 with a first predetermined wavelength in the visible spectrum, and emerges from the photoluminescent layer 22 with a second predetermined wavelength in the visible spectrum. In this way, by varying the size of the quantum dots, it is possible to obtain luminous radiation at the output of the light guide 6, the color of which is selectively customizable. Advantageously, the first predetermined wavelength is substantially equal to 450 nm (which corresponds to a blue color), this meaning that the electrical control circuit 4 imposes a predefined voltage value corresponding to a wavelength of 450 nm for the radiation reflected at the output of the layer of electrochromic material 18.

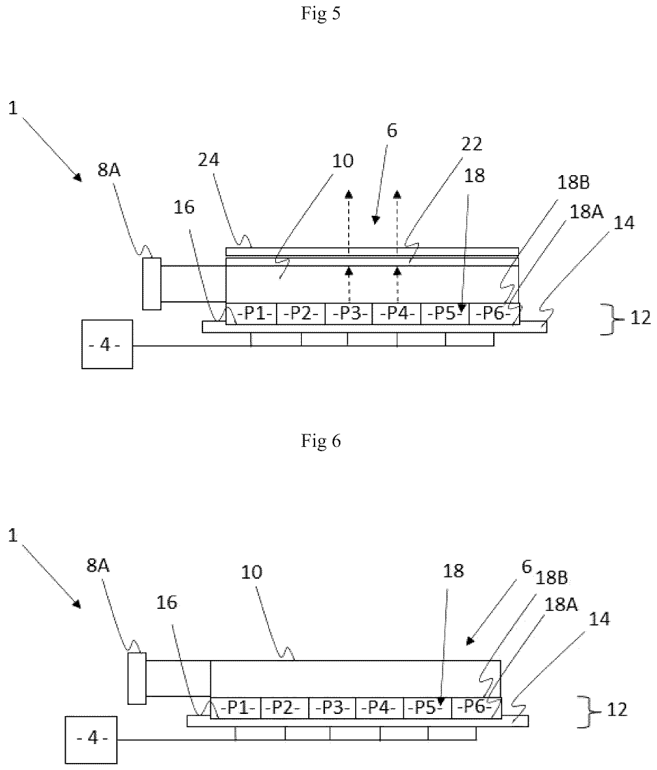

FIG. 6 shows the luminous device 1 according to a third embodiment of the invention, in which the light guide 6 comprises neither a layer of phosphor material 20 nor a photoluminescent layer 22 of quantum dot nano-materials.

A method of controlling the luminous device 1 described above, implemented by the electrical control circuit 4, is described below.

When a user or a third-party system of the vehicle wishes to generate a visual animation on the luminous device 1, the latter sends a setpoint to the electrical control circuit 4. This setpoint is representative of a set of voltages to be applied to the elements or pixels of the layer of electrochromic material 18 (via their respective pairs of electrodes). The set of voltages expresses a colored pattern that is to be displayed on the light guide 6 via the elements or pixels P1, P2, P3, . . . PN. The electrical control circuit 4 may selectively turn off or turn on the elements or pixels P1, P2, P3, . . . PN, and control the supply voltage to the latter in order to modify the color emitted by them. In order to generate a visual animation or to see, if necessary, the continuously illuminated light guide 6, the electrical control circuit 4 controls the voltage across the terminals of each pair of electrodes at high frequency, typically at a frequency of substantially between 10 Hz and 50 Hz.

The lighting beam generated by the light guide 6 of the luminous device 1 may advantageously be used to perform a regulatory photometric function, in particular a photometric lighting and/or signaling function of a vehicle, and preferably a direction-indicating function of the vehicle. The lighting beam generated by the luminous device 1 may also be used to perform a photometric function of “daytime running light” type, or else be used within interior lighting of a vehicle (the luminous module being, for example, mounted in the ceiling light of the vehicle), or else to produce a signature or visual animations on the vehicle.

What is claimed is:

1. A vehicle luminous device comprising an at least partially transparent or translucent light guide, and a luminous source arranged at one end of the light guide, the light guide includes a transparent or translucent core, the luminous source being configured to emit a source beam into the core of the light guide, the core of the light guide extending along a longitudinal axis and the luminous rays coming from the luminous source propagating in the core along the longitudinal axis by total internal reflection, the core being configured so as to allow the luminous rays to exit the core via an exit side face the normal of which is perpendicular to the longitudinal axis,
the light guide also includes a multilayer structure attached to the core and includes a substrate, a reflective layer, and a layer of electrochromic material structured into a plurality of elements, each element being encapsulated in a layer of electrolyte and being connected to a pair of electrodes capable of receiving a voltage, each element being capable of receiving luminous rays incident from a surface and of returning luminous rays from among the luminous rays incident from the surface, the returned luminous rays having a wavelength within a range defined at least by properties of the electrochromic material of the layer and/or by a thickness of the layer of electrochromic material, and
an electrical control circuit configured to control the voltage across the terminals of each pair of electrodes such that when the electrical control circuit imposes a predefined voltage value across the terminals of at least one of the pairs of electrodes, the luminous rays coming from the source beam and reflected by the reflective layer emerge from the corresponding element into the core of the light guide with a predetermined wavelength in the visible spectrum, the wavelength being a function of the predefined voltage value across the terminals of the at least one pair of electrodes.

2. The luminous device as claimed in claim 1, wherein the luminous source is configured to emit a monochrome source beam having the predetermined wavelength in the visible spectrum.

3. The luminous device as claimed in claim 1, wherein the luminous source is a laser source or a light-emitting diode.

4. The luminous device as claimed in claim 1, wherein the electrochromic material belongs to the family of organic transparent conductive oxide materials, a transparent conductive polymer of PEDOT:PSS, PEDOT:Tos, T34bT, or cellulose type.

5. The luminous device as claimed in claim 1, wherein the light guide is a diffusing and/or flexible optical fiber.

6. The luminous device as claimed in claim 1, wherein the voltage across the terminals of each pair of electrodes is between −1 V and +1 V.

7. The luminous device as claimed in claim 1, wherein the light guide includes a layer of phosphor material attached to the core of the light guide, opposite the multilayer structure.

8. The luminous device as claimed in claim 1, wherein the light guide includes a photoluminescent layer of quantum dot nano-materials, the photoluminescent layer being attached to the core of the light guide, opposite the multilayer structure.

9. The luminous device as claimed in claim 8, wherein the size of the quantum dots is chosen such that the light coming from the multilayer structure passes through the photoluminescent layer with a first predetermined wavelength in the visible spectrum, and emerges from the photoluminescent layer with a second predetermined wavelength in the visible spectrum.

10. The luminous device as claimed in claim 8, wherein the light guide includes an encapsulation layer encapsulating the photoluminescent layer.

11. The luminous device as claimed in claim 1, wherein the substrate of the multilayer structure is provided with a power supply ribbon cable connected on the one hand to the electrical control circuit and on the other hand to the terminals of each pair of electrodes.

12. The luminous device as claimed in claim 11, wherein the power supply ribbon cable consists of a flexible printed circuit board or of a film on which electronic components are printed.

13. A vehicle comprising a luminous device, the luminous device includes an at least partially transparent or translucent light guide, and a luminous source arranged at one end of the light guide, the light guide includes a transparent or translucent core, the luminous source being configured to emit a source beam into the core of the light guide, the core of the light guide extending along a longitudinal axis and the luminous rays coming from the luminous source propagating in the core along the longitudinal axis by total internal reflection, the core being configured so as to allow the luminous rays to exit the core via an exit side face the normal of which is perpendicular to the longitudinal axis,
the light guide also includes a multilayer structure attached to the core and includes a substrate, a reflective layer, and a layer of electrochromic material structured into a plurality of elements, each element being encapsulated in a layer of electrolyte and being connected to a pair of electrodes capable of receiving a voltage, each element being capable of receiving luminous rays incident from a surface and of returning luminous rays from among the luminous rays incident from the surface, the returned luminous rays having a wavelength within a range defined at least by properties of the electrochromic material of the layer and/or by a thickness of the layer of electrochromic material, and
an electrical control circuit configured to control the voltage across the terminals of each pair of electrodes such that when the electrical control circuit imposes a predefined voltage value across the terminals of at least one of the pairs of electrodes, the luminous rays coming from the source beam and reflected by the reflective layer emerge from the corresponding element into the core of the light guide with a predetermined wavelength in the visible spectrum, the wavelength being a function of the predefined voltage value across the terminals of the at least one pair of electrodes.

14. A method of controlling a vehicle luminous device, the method being implemented by an electrical control circuit and comprises controlling at least one voltage across terminals of a pair of electrodes of an element of a multilayer structure, depending on a setpoint, the setpoint being such that light coming from a source beam and reflected by a reflective layer passes through the element and emerges into a core of a light guide with a predetermined wavelength in the visible spectrum.

15. (canceled)
